(19) United States
(12) Patent Application Publication
(10) Pub. No.: US 2021/0056244 A1
(43) Pub. Date: Feb. 25, 2021

(54) METHOD OF MODELING, SIMULATION AND FAULT INJECTION FOR COMBINED HIGH PRESSURE GEAR PUMP FOR AEROENGINE

(71) Applicant: DALIAN UNIVERSITY OF TECHNOLOGY, Liaoning, CN (US)

(72) Inventors: Ximing SUN, Liaoning (CN); Xian DU, Liaoning (CN); Yanhua MA, Liaoning (CN)

(21) Appl. No.: 16/763,318

(22) PCT Filed: Feb. 25, 2019
(86) PCT No.: PCT/CN2019/076063

§ 371 Date: May 12, 2020

(51) Int. Cl. G06F 30/20; F04C 23/00; F04D 13/12

(52) U.S. Cl. CPC G06F 30/20; G06F 2119/02; F04D 13/12; F04C 23/005

(57) ABSTRACT

The present invention belongs to the technical field of modeling and simulation of an aeroengine, and provides a method of modeling, simulation and fault injection for a combined high pressure gear pump for an aeroengine, which comprises: extracting the flow regions of a centrifugal pump and a gear pump in the aeroengine and merging into a combined flow region; dividing the combined flow region into different units according to a working principle; meshing each unit by a finite element analysis method, and setting boundary conditions and media parameters; simulating in Pumplinx to obtain the operation performance of the pumps, and adjusting the lateral clearance of the gear to debug the simulation model till a simulation error is within 5%; and then setting faults based on the debugged model to obtain the change of the operation performance of the pumps under the faults.

### TECHNICAL FIELD

The present invention relates to a method of modeling, simulation and fault injection for a combined high pressure gear pump for an aeroengine, and belongs to the technical field of modeling and simulation of the aeroengine.

### BACKGROUND

A fuel pump is an important component in the fuel system of the aeroengine. With the continuous improvement of the operation performance requirements for the aeroengine, the performance requirements for the fuel pump are also higher and higher. When the operation performance of the fuel pump is researched, the simple use of a traditional physical experiment consumes time and labor, and is difficult to change parameters or conditions. If functional modeling is used, it is difficult to reflect the influences of the number of teeth and clearance of gears. The results are often deviated from the actual results. Moreover, the mathematical modeling of some large systems often requires the simulation results of the fuel pump as reference data. Thus, high precision modeling and simulation for the fuel pump is really necessary.

At present, the simulation of the pump is separate simulation of a centrifugal pump, a gear pump and the like. The separate simulation cannot reflect the interaction between the pumps. To solve the problem and improve the precision of modeling, the present invention provides a method of modeling, simulation and fault injection for a combined high pressure gear pump for an aeroengine. The method extracts flow regions according to the structures of the centrifugal pump and the gear pump, combines the flow regions into a combined flow region, divides the combined flow region into different units according to its working principle, establishes a simulation model in Pumplinx to simulate the operation performance of the pumps, and makes the simulation errors within 5% through debugging. The method also establishes fault models under several common faults to observe the change of the operation performance of the pumps under the faults, and provides reference for fault analysis and optimum design of the pumps.

### SUMMARY

In view of the problem that the simulation of fuel pump in the prior art only has separate simulation and is low in precision, the present invention provides a method of modeling, simulation and fault injection for a combined high pressure gear pump for an aeroengine.

The technical solution of the present invention is:

The method of modeling, simulation and fault injection for the combined high pressure gear pump for the aeroengine comprises the following steps:

S1. using UG to extract the flow regions of a centrifugal pump according to a three-dimensional model of the centrifugal pump

S1.1 using UG to create a cylindrical entity including the flow regions of the centrifugal pump, and intersecting with the centrifugal pump to obtain a preliminary flow region;

S1.2 trimming the preliminary flow region to remove the parts that do not belong to the flow region;

S1.3 optimizing the flow region to remove a clearance between an inducer and an impeller;

S1.4 dividing the flow region into different units according to the working principle, including four parts: an inlet unit, an inducer unit, an impeller unit and an outlet unit; firstly, creating a plane sheet which is flush with an inlet of a chamber of the inducer, and using the plane sheet to divide the flow region, with the inlet unit positioned above; then, creating a cylindrical sheet which is flush with an outlet of the chamber of the impeller, using the cylindrical sheet to divide the residual flow regions and separating out the outlet unit; then, creating a conical sheet having a vertex on a rotary shaft of the centrifugal pump, a surface between the impeller and the inducer and not intersecting with the teeth of the two gears, using the conical sheet to divide the residual flow regions and preliminarily separating the impeller part from the inducer part; finally, creating a plane sheet perpendicular to the rotary shaft of the centrifugal pump and higher than the bottom of the inducer, and using the plane sheet to divide the inducer part to obtain the plane sheet with an upper art as the inducer unit and a lower part which is merged with the impeller part to form the impeller unit;

S2. using UG to extract the flow regions of a gear pump according to a three-dimensional model of the gear pump

S2.1 using UG to create a cylindrical entity including the flow regions of the gear pump, and intersecting with the gear pump to obtain a preliminary flow region;

S2.2 trimming the preliminary flow region to remove the parts that do not belong to the flow region of the gear pump;

S2.3 optimizing the flow region, cutting and simplifying an inlet pipeline of the gear pump, and extruding at the inlet to generate a small cylinder to facilitate simulation settings;

S2.4 dividing the flow region into different units according to the working principle, including five parts: an inlet unit, a gear unit, unloading groove units, expended high pressure area units and an outlet unit; firstly, creating a sheet which coincides with a gear cavity wall and penetrates through the flow region of the gear pump, and using the sheet to divide the flow region to obtain the inlet unit and the outlet unit; then, creating plane sheets which are respectively flush with the upper surface and the lower surface of the gear, and using the two sheets to divide the residual flow regions to obtain the gear unit; finally, creating a sheet which coincides with the outer wall surface of an unloading groove, and using the sheet to divide the residual flow regions to obtain four unloading groove units and eight expended high pressure area units;

S3. merging the flow regions of the centrifugal pump and the gear pump to form a combined flow region

S3.1 extracting the flow region of a lower connecting pipeline of the centrifugal pump in the model;

S3.2 importing the flow region of the centrifugal pump, the flow region of the gear pump, and the flow region of the connecting pipeline into a model file; rotating and translating the flow region of the gear pump till the inlet of the gear pump is parallel to the outlet of the connecting pipeline and the center of a circle of the outlet of the connecting pipeline is on the centerline of the small cylinder at the inlet of the gear pump;

S3.3 creating a round table between the inlet of the gear pump and the outlet of the connecting pipeline to connect the flow region of the gear pump and the flow region of the connecting pipeline;

S3.4 merging the inlet unit of the gear pump, the flow region of the connecting pipeline and the outlet unit of the centrifugal pump as a combined flow region model;

S4. importing the combined flow region model into Pumplinx for creating a simulation model

S4.1 importing a combined pump flow region model into pumplinx and establishing four monitoring points, i.e., a rotary center of a gear pump driving gear, a rotary center of a slave gear, a combined pump inlet and a combined pump outlet;

S4.2 scaling x, y and z directions of the combined flow region model till the positions of the monitoring points coincide with the actual positions, and unifying the unit;

S4.3 performing the “Split Disconnected” operation on the combined flow region, dividing the combined flow region into different units according to the modes in S1.4 and S2.4, and creating a Surface for each unit in sequence;

S4.4 meshing each unit, using a rotor template mesher for the meshing of the gear unit, and using an ordinary mesher for the meshing of the other units;

S4.5 arranging interfaces for connected units, comprising an inlet unit and an inducer unit, an inducer unit and an impeller unit, an impeller unit and a connecting unit of the centrifugal pump and the gear pump, a gear unit and a connecting unit of the centrifugal pump and the gear pump, a gear unit and an outlet unit, a gear unit and an unloading groove unit, a gear unit and an expended high pressure area unit, and an unloading groove unit at an outlet side and an expended high pressure area unit;

S4.6 adding modules, comprising “Axial Flow”, “Centrifugal” and “Gear” three rotor modules and “Turbulence”, “Cavitation”, “Heat”, “Streamline” and “Particle” modules, and setting parameters of the modules;

S4.7 setting boundary conditions;

S4.8 setting media parameters;

S5. debugging the simulation model and adjusting the lateral clearance of the gear for different states till the errors between the simulation results and the experimental data are within 5%;

S6. conducting fault injection on the simulation model under a rated state

S6.1 selecting the simulation model under the rated state for fault injection; and selecting model fault parameter setting manners for three fault modes of no pressurization of centrifugal pump outlet fuel, reduced pressurization of centrifugal pump outlet fuel, and reduced flow of gear pump fuel supply;

S6.2 for no pressurization fault of centrifugal pump outlet fuel, setting rotary speed of the impeller and the inducer as 0 in Pumplinx for simulation;

S6.3 for reduced pressurization fault of centrifugal pump outlet fuel, respectively thickening the corresponding flow regions of the inducer and the impeller in UG to increase the clearance;

S6.4 for reduced flow fault of gear pump fuel supply, thinning the teeth of the gear in UG to increase the radial clearance; when meshing the gear unit in Pumplinx, increasing the lateral clearance, i.e., the value of “Side Leakage Gap”;

S7. respectively simulating the simulation model under each fault to obtain the change of pump performance under each fault.

The present invention has the following beneficial effects: the method provided by the present invention reflects the interaction between the centrifugal pump and the gear pump and increases the simulation precision when conducting modeling, simulation and fault injection on the fuel pump of the aeroengine compared with the existing method. Fuel pump simulation data can be used for mathematical modeling of a fuel and actuating system of the aeroengine. Therefore, the method can directly enhance the precision and the reliability of mathematical modeling of the fuel and actuating system of the aeroengine. Meanwhile, the method can be used for modeling and simulation of other types of fuel pumps after proper adjustment, and has certain universality.

### DESCRIPTION OF DRAWINGS

FIG. 1 is a flow chart of a method of modeling, simulation and fault injection for a combined high pressure gear pump for an aeroengine;

FIG. 2 is a flow chart of extracting a pump flow region;

FIG. 3 is a flow chart of merging flow regions;

FIG. 4 is a model diagram of a combined flow region;

FIG. 5 is a flow chart of creating Pumplinx simulation model;

FIG. 6 is a simulation outlet flow-time relationship diagram under a fault that rotary seed of an impeller and an inducer is 0;

FIG. 7 is a simulation outlet flow-time relationship diagram under a fault that a radial clearance is increased to 0.45 mm; and

FIG. 8 is a simulation outlet flow-time relationship diagram under a fault that a lateral clearance is increased to 0.1 mm.

### DETAILED DESCRIPTION

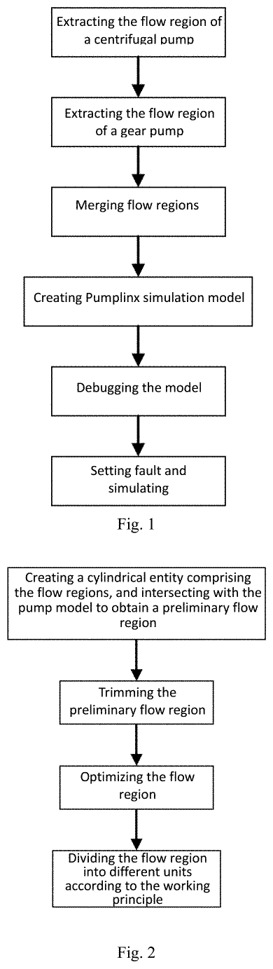

The present invention is further described below in combination with the drawings. The present invention replies on the background of a three-dimensional model and experimental data of a fuel pump of a certain type of aeroengine. A method flow of modeling, simulation and fault injection for a combined high pressure gear pump for an aeroengine is shown in FIG. 1.

FIG. 2 is a flow chart of extracting a pump flow region. The steps of extracting the flow region of the centrifugal pump are as follows:

S1. using UG to create a cylindrical entity including the flow regions of the centrifugal pump, and intersecting with the centrifugal pump to obtain a preliminary flow region;

S2. trimming the preliminary flow region, creating a cylindrical entity having the same diameter as the rotary shaft, subtracting the cylindrical entity and the flow region, and remove the middle rotary shaft part; creating a cylindrical entity having the same diameter as a housing below the impeller, subtracting the cylindrical entity and the flow region and making the clearance value below the impeller as 0.15 mm; removing other parts which do not belong to the flow region step by step through the commands of “extrude”, “TrimBody” and “subtract”;

S3. optimizing the flow region to remove a clearance between an inducer and an impeller; creating a cylindrical sheet having the same inner diameter as the bottom of the inducer; dividing the flow region part and removing the clearance after dividing; merging the residual divided parts to the flow region;

S4. dividing the flow region of the centrifugal pump into different units according to the working principle, including four parts: an inlet unit, an inducer unit, an impeller unit and an outlet unit; firstly, creating a plane sheet which is flush with an inlet of a chamber of the inducer, and using the sheet to divide the flow region, with the inlet unit positioned above; creating a cylindrical sheet which is flush with an outlet of the chamber of the impeller, using the sheet to divide the residual flow regions and separating out the outlet unit; creating a conical sheet having a vertex on a rotary shaft of the centrifugal pump, a surface between the impeller and the inducer and not intersecting with the teeth of the two gears, using the sheet to divide the residual flow regions and preliminarily separating the impeller part from the inducer part; creating a plane sheet perpendicular to the rotary shaft of the centrifugal pump and slightly higher than the bottom of the inducer, and using the sheet to divide the inducer part to obtain the sheet with an upper art as the inducer unit and a lower part which is merged with the impeller part to form the impeller unit.

The steps of extracting the flow region of the gear pump are as follows:

S1. using UG to firstly create a cylindrical entity including the flow regions of the gear pump, and intersecting with the gear pump to obtain a preliminary flow region;

S2. trimming the preliminary flow region to remove the parts that do not belong to the flow region of the gear pump;

S3. optimizing the flow region, cutting and simplifying an inlet pipeline of the gear pump, and extruding at the inlet to generate a small cylinder to facilitate simulation settings;

S4. dividing the flow region into different units according to the working principle, including five units: an inlet unit, a gear unit, unloading groove units, expended high pressure area units and an outlet unit; firstly, creating a sheet which coincides with a gear cavity wall and penetrates through the flow region of the gear pump, and using the sheet to divide the flow region to obtain the inlet unit and the outlet unit; creating plane sheets which are respectively flush with the upper surface and the lower surface of the gear, and using the two sheets to divide the residual flow regions to obtain the gear unit; creating a sheet which coincides with the outer wall surface of an unloading groove, and using the sheet to divide the residual flow regions to obtain four unloading groove units and eight expended high pressure area units.

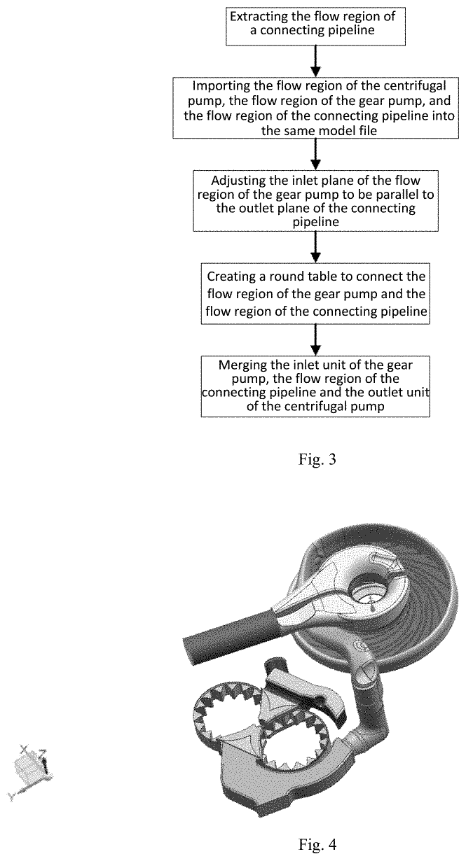

FIG. 3 is a flow chart of merging flow regions. The steps of merging flow regions are as follows:

51. extracting the flow region of a lower connecting pipeline of the centrifugal pump in the model;

S2. importing the flow region of the centrifugal pump, the flow region of the gear pump, and the flow region of the connecting pipeline into a model file; rotating and translating the flow region of the gear pump till the inlet of the gear pump is parallel to the outlet of the connecting pipeline and the center of a circle of the outlet of the connecting pipeline is on the centerline of the small cylinder at the inlet of the gear pump;

S3. creating a round table between the inlet of the gear pump and the outlet of the connecting pipeline to connect the flow region of the gear pump and the flow region of the connecting pipeline;

S4. merging the inlet unit of the gear pump, the flow region of the connecting pipeline and the outlet unit of the centrifugal pump.

FIG. 4 is a model diagram of a combined flow region which is finally formed.

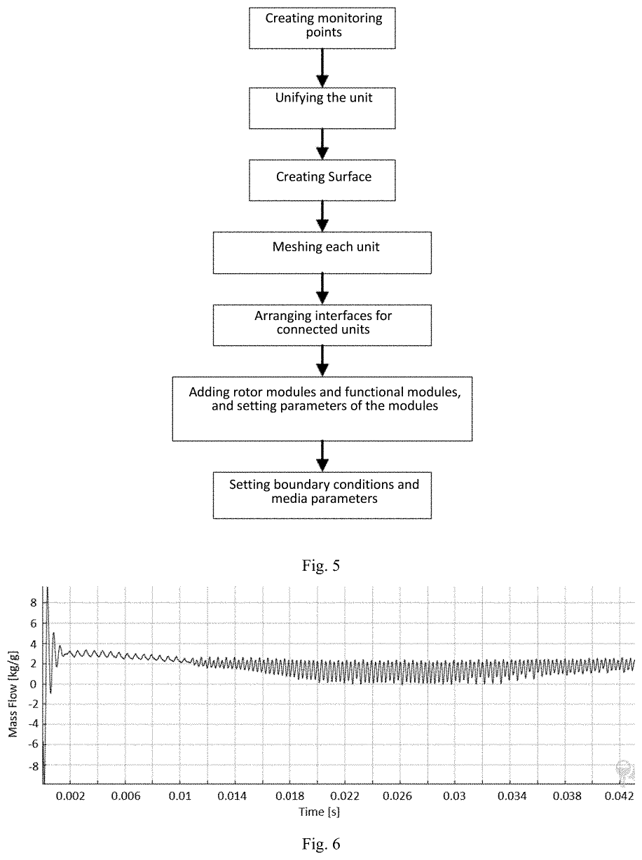

FIG. 5 is a flow chart of creating Pumplinx simulation model. The steps of creating Pumplinx simulation model are as follows:

51. importing a combined pump flow region model into pumplinx and establishing four monitoring points, i.e., a rotary center of a gear pump driving gear, a rotary center of a slave gear, an inlet and an outlet;

S2. scaling x, y and z directions of the model according to a scale factor of 0.001, and making the positions of the monitoring points coincide with the actual positions, and then completing the unifying of the unit;

S3. performing the “Split Disconnected” operation on the flow region, dividing the flow region into different units, and creating a Surface for each unit in sequence; creating three Surfaces of “inlet_inlet”, “inlet_mgi_youdao” and “inlet_walls” for the inlet unit; creating four Surfaces of “youdao_mgi_inlet”, “youdao_mgi_yelun”, “youdao” and “youdao_walls” for the inducer unit; creating five Surfaces of “yelun_mgi_youdao”, “yelun_mgi_connect”, “yelun”, “yelun_bot” and “yelun walls” for the impeller unit; creating four Surfaces of “connect_mgi_yelun”, “connect_mgi_drive”, “connect_mgi_slave” and “connect_walls” for the connecting unit of the centrifugal pump and the gear pump; creating six Surfaces of “gear_drive_shroud”, “gear_slave_shroud”, “gears_outer_top”, “gears_outer_bottom”, “gears_drive” and “gears_slave” for the gear unit; creating two Surfaces of “relief top inlet_mgi gears” and “relief top inlet_walls” for the unloading groove unit above the inlet of the gear pump, the same for the unloading groove unit below the inlet of the gear pump; creating four Surfaces of “relief top outlet_mgi gears”, “relief top outlet_mgi_expand1”, “relief top outlet_mgi_expand2” and “relief top outlet_walls” for the unloading groove unit above the outlet of the gear pump, the same for the unloading groove unit below the outlet of the gear pump; respectively creating three Surfaces of “expand_bottom_drive_mgi_gears”, “expand_bottom_drive_mgi_relief” and “expand_bottom_drive_walls” for four expended high pressure area units; creating four Surfaces of “outlet_mgi_drive”, “outlet_mgi_slave”, “outlet_outlet” and “outlet_walls” for the outlet unit;

S4. conducting meshing; using a rotor template mesher for the gear unit; selecting “External Gear” as the rotor type, selecting “Advanced Mode” as the setting mode; making the gap inner radius and the gap outer radius as 27.05 mm and 41.7 mm respectively; for a vortex chamber part, when meshing, setting a maximum cell size as 0.01 and setting a cell size on surfaces as 0.005; for other units, when meshing, setting the maximum cell size as 0.02 and setting the cell size on surfaces as 0.01; integrating some small broken surfaces that appear during meshing to adjacent surface meshes by using “Combine” function in Split/Combine Geometry or Grid;

S5. arranging interfaces for connected units, comprising an inlet unit and an inducer unit, an inducer unit and an impeller unit, an impeller unit and a connecting unit of the centrifugal pump and the gear pump, a gear unit and a connecting unit of the centrifugal pump and the gear pump and an outlet unit, a gear unit and an unloading groove and an expended high pressure area, an unloading groove and an expended high pressure area at an outlet side;

S6. adding modules, comprising “Axial Flow”, “Centrifugal” and “Gear” three rotor modules and “Turbulence”, “Cavitation”, “Heat”, “Streamline” and “Particle” modules; arranging an axial flow corresponding inducer, and setting number of blades as 5, coordinates of a rotor center as [0 0 0] with counterclockwise rotation, and a rotational axis vector as [0 0 1]; arranging a centrifugal corresponding impeller, and setting number of blades as 18, coordinates of a rotor center as [0 0 0] with counterclockwise rotation, and a rotational axis vector as [0 0 1]; setting the number of teeth of the driving gear and the slave gear as 16 with counterclockwise rotation and a rotational axis vector as [0 0 1]; selecting the gear pump as a reference pump, number of revolutions as 10 and time steps per drive gear tooth rotation as 30;

S7. setting boundary conditions; setting the boundary surface “youdao” as the axial rotor and changing corresponding option of Axial Flow as “Rotor”; setting the boundary surface “yelun” as the centrifugal rotor and changing corresponding option of Centrifugal as “Rotor”; setting inlet pressure for the boundary surface “inlet_inlet”, changing corresponding option of Axial Flow as “Inlet”, and inputting an inlet pressure value; setting outlet pressure for the boundary surface “outlet_outlet”, changing corresponding option of Gear as “Outlet”, and inputting an outlet pressure value;

S8. setting media parameters which are shown in Table 1.

TABLE 1
Table of Media Parameters and Values

| Media Parameters | Values | |
|---|---|---|
| Dynamic Viscosity | 0.001154 | Pa · s |
| Density | 780 | kg/m3 |
| Liquid Bulk Modulus(B0) | 1.5 × 109 | Pa |
| Linear Bulk Modulus(B1) | 0 | |
| Liquid Reference Pressure | 101325 | Pa |
| Saturation Pressure | 3000 | Pa |
| Heat Capacity | 4180 | J/kg · K |

Eight states shown in Table 2 are simulated, and the simulation model is debugged by adjusting the lateral clearance of the gear to obtain comparison of simulation results and experimental data as shown in Table 3. The errors are within 5%.

TABLE 2
Boundary Conditions of Eight States

| | Boundary Conditions | | |
|---|---|---|---|
| | Rotary | Centrifugal Pump | Gear Pump |
| | Speed | Inlet Pressure | Outlet Pressure |
| States | (r/min) | (MPa) | (MPa) |
| 1 | 6250 | 0.345 | 2.896 |
| 2 | 6250 | 0.345 | 7.895 |
| 3 | 3000 | 0.345 | 1.4 |
| 4 | 3000 | 0.345 | 6.9 |
| 5 | 4000 | 0.345 | 1.4 |
| 6 | 4000 | 0.345 | 8.3 |
| 7 | 5000 | 0.345 | 2.8 |
| 8 | 5000 | 0.345 | 9 |

TABLE 3
Comparison of Outlet Flow Simulation
Results and Experimental Data

| | Experimental Data | Simulation Results | |
|---|---|---|---|
| States | (kg/s) | (kg/s) | Error |
| 1 | 3.1778 | 3.25 | 2.27% |
| 2 | 3.0922 | 3.23 | 4.46% |
| 3 | 1.5083 | 1.48 | 1.88% |
| 4 | 1.4417 | 1.38 | 4.27% |
| 5 | 2.03 | 2.07 | 1.97% |
| 6 | 1.9161 | 1.825 | 4.75% |
| 7 | 2.5417 | 2.525 | 0.66% |
| 8 | 2.3714 | 2.375 | 0.15% |

FIGS. 6-8 show model simulation results under various faults. The steps of fault injection are as follows:

S1. selecting the simulation model under the rated state for fault injection; and selecting a model fault parameter setting manner for three fault modes of no pressurization of centrifugal pump outlet fuel, reduced pressurization of centrifugal pump outlet fuel, and reduced flow of gear pump fuel supply, as shown in Table 4;

TABLE 4
Fault Mode and Corresponding Model
Fault Parameter Setting Manner

| Fault Mode | Model Fault Parameter Setting Manner |
|---|---|
| No pressurization of | The rotary speed of the |
| centrifugal pump outlet fuel | centrifugal pump is 0 |
| Reduced pressurization | The clearance between the |
| of centrifugal pump | inducer and the housing is |
| outlet fuel | increased |
| | The clearance between the |
| | impeller and the housing is |
| | increased |
| Reduced flow of gear pump | The radial clearance is |
| fuel supply | increased |
| | The lateral clearance is |
| | increased |

S2. for no pressurization fault of centrifugal pump outlet fuel, setting rotary speed of the impeller and the inducer as 0 in Pumplinx for simulation to obtain fuel pump outlet flow of 1.8 kg/s, as shown in FIG. 6;

S3. for reduced pressurization fault of centrifugal pump outlet fuel, respectively thickening the corresponding flow regions of the inducer and the impeller in UG to increase the clearance; when simulating to obtain an increase of 1.5 mm in the clearance between the inducer and the housing, the centrifugal pump outlet pressure being 0.75 MPa, and when increasing the clearance between the impeller and the housing by 1 mm, the centrifugal pump outlet pressure being 1.0 MPa;

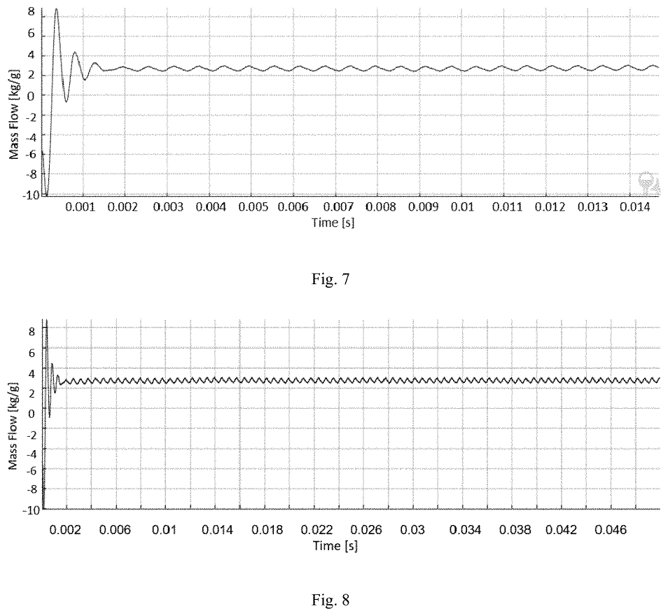

S4. for reduced flow fault of gear pump fuel supply, thinning the teeth of the gear in UG to increase the radial clearance; when the clearance is 0.45 mm, simulating to obtain fuel pump outlet flow of 2.7925 kg/s, as shown in FIG. 7; when meshing the gear unit in Pumplinx, increasing the value of “Side Leakage Gap”; and when the clearance is 0.1 mm, the fuel pump outlet flow being 2.774 kg/s, as shown in FIG. 8.

1. A method of modeling, simulation and fault injection for a combined high pressure gear pump for an aeroengine, comprising the following steps:
S1. using UG to extract the flow regions of a centrifugal pump according to a three-dimensional model of the centrifugal pump
S1.1 using UG to create a cylindrical entity comprising the flow regions of the centrifugal pump, and intersecting with the centrifugal pump to obtain a preliminary flow region;
S1.2 trimming the preliminary flow region to remove the parts that do not belong to the flow region;
S1.3 optimizing the flow region to remove a clearance between an inducer and an impeller;
S1.4 dividing the flow region into different units according to the working principle, comprising four parts: an inlet unit, an inducer unit, an impeller unit and an outlet unit; firstly, creating a plane sheet which is flush with an inlet of a chamber of the inducer, and using the plane sheet to divide the flow region, with the inlet unit positioned above; then, creating a cylindrical sheet which is flush with an outlet of the chamber of the impeller, using the cylindrical sheet to divide the residual flow regions and separating out the outlet unit; then, creating a conical sheet having a vertex on a rotary shaft of the centrifugal pump, a surface between the impeller and the inducer and not intersecting with the teeth of the two gears, using the conical sheet to divide the residual flow regions and preliminarily separating the impeller part from the inducer part; finally, creating a plane sheet perpendicular to the rotary shaft of the centrifugal pump and higher than the bottom of the inducer, and using the plane sheet to divide the inducer part to obtain the plane sheet with an upper art as the inducer unit and a lower part which is merged with the impeller part to form the impeller unit;
S2. using UG to extract the flow regions of a gear pump according to a three-dimensional model of the gear pump
S2.1 using UG to create a cylindrical entity comprising the flow regions of the gear pump, and intersecting with the gear pump to obtain a preliminary flow region;
S2.2 trimming the preliminary flow region to remove the parts that do not belong to the flow region of the gear pump;
S2.3 optimizing the flow region, cutting and simplifying an inlet pipeline of the gear pump, and extruding at the inlet to generate a small cylinder to facilitate simulation settings;
S2.4 dividing the flow region into different units according to the working principle, comprising five parts: an inlet unit, a gear unit, unloading groove units, expended high pressure area units and an outlet unit; firstly, creating a sheet which coincides with a gear cavity wall and penetrates through the flow region of the gear pump, and using the sheet to divide the flow region to obtain the inlet unit and the outlet unit; then, creating plane sheets which are respectively flush with the upper surface and the lower surface of the gear, and using the two sheets to divide the residual flow regions to obtain the gear unit; finally, creating a sheet which coincides with the outer wall surface of an unloading groove, and using the sheet to divide the residual flow regions to obtain four unloading groove units and eight expended high pressure area units;
S3. merging the flow regions of the centrifugal pump and the gear pump to form a combined flow region
S3.1 extracting the flow region of a lower connecting pipeline of the centrifugal pump in the model;
S3.2 importing the flow region of the centrifugal pump, the flow region of the gear pump, and the flow region of the connecting pipeline into a model file; rotating and translating the flow region of the gear pump till the inlet of the gear pump is parallel to the outlet of the connecting pipeline and the center of a circle of the outlet of the connecting pipeline is on the centerline of the small cylinder at the inlet of the gear pump;
S3.3 creating a round table between the inlet of the gear pump and the outlet of the connecting pipeline to connect the flow region of the gear pump and the flow region of the connecting pipeline;
S3.4 merging the inlet unit of the gear pump, the flow region of the connecting pipeline and the outlet unit of the centrifugal pump as a combined flow region model;
S4. importing the combined flow region model into Pumplinx for creating a simulation model
S4.1 importing a combined pump flow region model into pumplinx and establishing four monitoring points, i.e., a rotary center of a gear pump driving gear, a rotary center of a slave gear, a combined pump inlet and a combined pump outlet;
S4.2 scaling x, y and z directions of the combined flow region model till the positions of the monitoring points coincide with the actual positions, and unifying the unit;
S4.3 performing the “Split Disconnected” operation on the combined flow region, dividing the combined flow region into different units according to the modes in S1.4 and S2.4, and creating a Surface for each unit in sequence;
S4.4 meshing each unit, using a rotor template mesher for the meshing of the gear unit, and using an ordinary mesher for the meshing of the other units;
S4.5 arranging interfaces for connected units, comprising an inlet unit and an inducer unit, an inducer unit and an impeller unit, an impeller unit and a connecting unit of the centrifugal pump and the gear pump, a gear unit and a connecting unit of the centrifugal pump and the gear pump, a gear unit and an outlet unit, a gear unit and an unloading groove unit, a gear unit and an expended high pressure area unit, and an unloading groove unit at an outlet side and an expended high pressure area unit;
S4.6 adding modules, comprising “Axial Flow”, “Centrifugal” and “Gear” three rotor modules and “Turbulence”, “Cavitation”, “Heat”, “Streamline” and “Particle” modules, and setting parameters of the modules;
S4.7 setting boundary conditions;
S4.8 setting media parameters;
S5. debugging the simulation model and adjusting the lateral clearance of the gear for different working conditions till the errors between the simulation results and the experimental data are within 5%;
S6. conducting fault injection on the simulation model under a rated state
S6.1 selecting the simulation model under the rated state for fault injection; and selecting model fault parameter setting manners for three fault modes of no pressurization of centrifugal pump outlet fuel, reduced pressurization of centrifugal pump outlet fuel, and reduced flow of gear pump fuel supply;
S6.2 for no pressurization fault of centrifugal pump outlet fuel, setting rotary speed of the impeller and the inducer as 0 in Pumplinx for simulation;
S6.3 for reduced pressurization fault of centrifugal pump outlet fuel, respectively thickening the corresponding flow regions of the inducer and the impeller in UG to increase the clearance;
S6.4 for reduced flow fault of gear pump fuel supply, thinning the teeth of the gear in UG to increase the radial clearance; when meshing the gear unit in Pumplinx, increasing the lateral clearance, i.e., the value of “Side Leakage Gap”;
S7. respectively simulating the simulation model under each fault to obtain the change of pump performance under each fault.
